(19) United States
(12) Patent Application Publication
(10) Pub. No.: US 2009/0286529 A1
(43) Pub. Date: Nov. 19, 2009

(54) WIRELESS REMOTE MONITORING SYSTEM AND METHOD THEREFOR

(76) Inventor: Wen-Ching CHANG, Taipei County (TW)

Correspondence Address: Muncy, Geissler, Olds & Lowe, PLLC, P.O. BOX 1364, FAIRFAX, VA, 22038-1364, US

(21) Appl. No.: 12/345,059

(22) Filed: Dec. 29, 2008

(30) Foreign Application Priority Data
May 16, 2008 (TW) 097118270

(51) Int. Cl. H04W 24/00

(52) U.S. Cl. 455/425

(57) ABSTRACT

A wireless remote monitoring system and a method therefor are provided. The wireless remote monitoring system includes a monitoring device, a communication network, and a mobile image capturing device. The monitoring device issues a monitoring message to the communication network through a worldwide interoperability for microwave access (WiMAX) communication protocol. The communication network is connected to the mobile image capturing device satisfying the monitoring message. The mobile image capturing device resolves the monitoring message, captures an image of a disposition site, and transmits the image back to the monitoring device. In addition, a predetermined time is set, and then the mobile image capturing device automatically transmits the obtained image of the disposition site to the monitoring device.

### CROSS-REFERENCE TO RELATED APPLICATION

This application claims the benefit of Taiwan Patent Application No. 097118270, filed on May 16, 2008, which is hereby incorporated by reference for all purposes as if fully set forth herein.

### BACKGROUND OF THE INVENTION

1. Field of Invention

The present invention relates to a wireless remote monitoring system and a method therefor, in particular, to a wireless remote monitoring system and a method therefor by using a worldwide interoperability for microwave access (WiMAX) communication protocol.

2. Related Art

Along with the development of wireless communication technology, the remote monitoring system has already been widely applied in our life, for example, used in bank security monitoring and real-time road traffic monitoring. Moreover, due to an increasing expansion of the application scope of the system, it is necessary to achieve a higher remote monitoring information transmission rate.

Currently, in a remote monitoring, generally a monitoring equipment captures an image message, compresses and transmits the message back to a monitoring end by a fixed data dedicated line or a wireless frequency shift keying (FSK) modem, and decompresses the image message to monitor a remote site. However, the above transmission manner has a low rate, and is unable to support a full-speed transmission, so that the frame rate of the image message is reduced and the reduced frame rate results in freeze-frame phenomenon.

### SUMMARY OF THE INVENTION

Accordingly, the present invention is directed to a wireless remote monitoring system, a monitoring method, and a mobile image capturing device, capable of transmitting a remote monitor image message in a worldwide interoperability for microwave access (WiMAX) communication protocol, so as to provide a high transmission rate of the image message.

The present invention provides a wireless remote monitoring system including a monitoring device, a communication network, and a mobile image capturing device. The mobile image capturing device has a mobile power source for providing an electric power required by the mobile image capturing device. In the wireless remote monitoring system, the monitoring device issues a monitoring message, and the communication network is connected to the mobile image capturing device so as to control the mobile image capturing device to obtain an image message of a disposition site and transmit the image message back to the monitoring device at the same time, thereby performing a remote image monitoring.

According to the present invention, a user issues a monitoring message including the query of a region location and the code of a mobile image capturing device through an operation interface of the monitoring device. Then the communication network is connected through a WiMAX communication protocol, and a computer room equipment of the communication network is connected to the mobile image capturing device satisfying the monitoring message. After identifying and determining the received monitoring message, each mobile image capturing device captures an image of the disposition site according to the content of the monitoring message, compresses and codes the image, and transmits the image back to the monitoring device through the communication network. After decompressing and decoding the image, the monitoring device plays the image or directly stores the image in the monitoring device for later query. For the remote monitoring, in addition to the above manner that the user issues the monitoring message to request the mobile image capturing device to monitor, a predetermined time may be set, and then the mobile image capturing device automatically transmits the obtained image of the disposition site back to the monitoring device. The present invention further provides a mobile image capturing device including a mobile power source, an image capture module, a signal receiving/transmitting interface, and a processor. The mobile power source provides an electric power required by the mobile image capturing device. The image capture module captures an analog image. The signal receiving/transmitting interface serves as a communication bridge with the communication network and receives/transmits the image obtained by the image capture module. The processor controls the image capture module to obtain an image of the disposition site of the mobile image capturing device, and transmits the image to a monitoring device through the signal receiving/transmitting interface by using a WiMAX communication protocol.

In the wireless remote monitoring system, the monitoring device, the communication network, and the mobile image capturing device of the present invention perform the remote image transmission through the WiMAX communication protocol, such that the transmission rate and speed are higher as compared with the transmission through a wireless FSK modem or a fixed data dedicated line. Moreover, when no image is transmitted, the power consumption is low, and the bandwidth is wide enough to connect a plurality of mobile image capturing devices at the same time, so as to facilitate the collection of several batches of information.

### BRIEF DESCRIPTION OF THE DRAWINGS

The present invention will become more fully understood from the detailed description given herein below for illustration only, and thus are not limitative of the present invention, and wherein:

FIG. 1 is a schematic view of a wireless remote monitoring system according to an embodiment of the present invention;

FIG. 2 is a block diagram of the wireless remote monitoring system according to the embodiment of the present invention; and

FIG. 3 is a flow chart of a wireless remote monitoring method according to the embodiment of the present invention.

### DETAILED DESCRIPTION OF THE INVENTION

In order to have a further understanding of the present invention, a detailed description is given below in embodiments with the accompanying drawings.

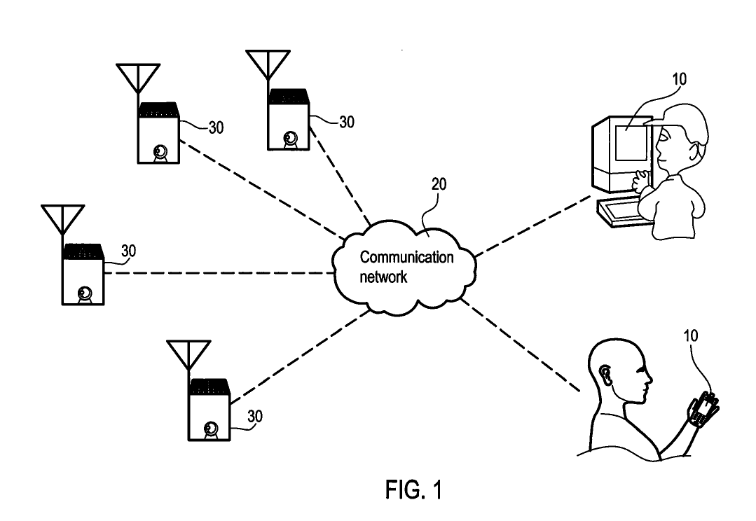

FIG. 1 is a schematic view of a wireless remote monitoring system according to an embodiment of the present invention. The system includes a monitoring device 10, a communication network 20, and a plurality of mobile image capturing devices 30. The monitoring device 10 is, but not limited to, an electronic device such as a computer, a mobile communication device, or a personal digital assistant (PDA), and the mobile image capturing devices 30 are, but not limited to, web cameras. The monitoring device 10 is connected to the communication network 20 through a worldwide interoperability for microwave access (WiMAX) communication protocol, and obtains images of disposition sites transmitted back by one or more mobile image capturing devices 30, such that the monitoring device 10 performs a real-time monitoring on one or more sites.

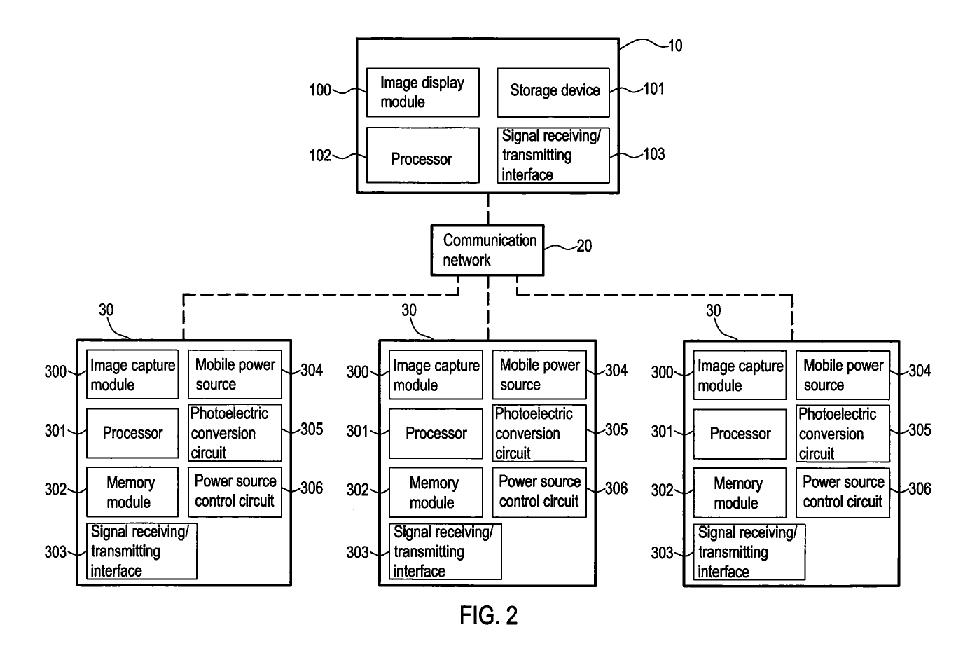

FIG. 2 is a block diagram of the wireless remote monitoring system according to the embodiment of the present invention. The monitoring device 10 includes an image display module 100 for displaying the images transmitted back by the mobile image capturing devices 30, a storage device 101 for storing the images to be queried when necessary, a processor 102 for decompressing and decoding the images transmitted back by the mobile image capturing devices 30, and a signal receiving/transmitting interface 103 serving as a communication bridge with the communication network 20.

The mobile image capturing device 30 includes an image capture module 300 for capturing the image of the disposition site, a processor 301 for compressing and coding the image obtained by the image capture module 300, a memory module 302 for temporarily storing the image during the compressing and coding process, a signal receiving/transmitting interface 303 serving as a communication bridge with the communication network 20, a mobile power source 304 for providing an electric power required by the mobile image capturing device 30 in a manner of configuring a solar panel on the mobile image capturing device 30 to receive the solar power and adopting a photoelectric conversion circuit 305 to convert the solar power into electric power or directly through a fuel cell for power supply, and a power source control circuit 306 for adjusting the electric power required by the mobile image capturing device 30 in different working states so as to reduce the power consumption of the mobile power source 304.

Further referring to FIG. 2, the mobile image capturing device 30 according to the embodiment of the present invention includes a mobile power source 304, an image capture module 300, a signal receiving/transmitting interface 303, and a processor 301 all configured in a single mobile image capturing device 30. The mobile power source 304 provides an electric power required by the mobile image capturing device 30. The image capture module 300 captures a real-time image. The signal receiving/transmitting interface transmits the real-time image or receives a monitoring message. The processor 301 integrates the above units. For example, after the signal receiving/transmitting interface 303 receives a monitoring message for transmitting back monitoring pictures, the processor 301 controls the image capture module 300 to obtain an image of the disposition site of the mobile image capturing device 30, and transmits the image to the assigned monitoring device 10 through the signal receiving/transmitting interface 303 by using the WiMAX communication protocol.

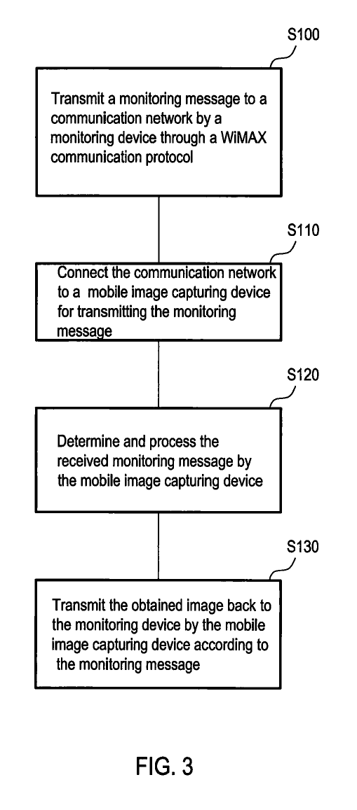

FIG. 3 is a flow chart of a wireless remote monitoring method according to the embodiment of the present invention. The method includes the following steps.

A monitoring device transmits a monitoring message to a communication network through a WiMAX communication protocol (Step S100). When a user intends to query an image of a disposition site, the monitoring device 10 issues a monitoring message including the query of a region location and the code of a mobile image capturing device 30 to the communication network 20 through a signal receiving/transmitting interface 103 by using a WiMAX communication protocol.

The communication network is connected to the mobile image capturing device for transmitting the monitoring message (Step S110). A computer room equipment of the communication network 20 is connected to the mobile image capturing device 30 satisfying the queried region location and the code of the mobile image capturing device 30 contained in the monitoring message, for capturing an image.

The mobile image capturing device determines and processes the received monitoring message (Step S120). After the signal receiving/transmitting interface 303 of the mobile image capturing device 30 receives the monitoring message issued by the monitoring device 10 to the communication network 20, the processor 301 resolves the monitoring message.

The mobile image capturing device transmits the received image back to the monitoring device according to the monitoring message (Step S130). The image capture module 300 is controlled to capture an image of the disposition site according to the resolved monitoring message, and meanwhile the image is compressed and coded to be temporarily stored in the memory module 302. After completing the image capturing, the mobile image capturing device 30 is connected to the communication network 20 through the signal receiving/transmitting interface 303, and transmits the image back to the monitoring device 10 through the communication network 20. The signal receiving/transmitting interface 103 of the monitoring device 10 receives the image captured by the mobile image capturing device 30, the processor 102 of the monitoring device 10 decompresses and decodes the image, and the image of the disposition site transmitted back is displayed on the image display module 100 or directly stored in the storage device 101 for later query of the user.

In the above implementation manner, the monitoring message transmitted by the monitoring device 10 further includes an Internet protocol (IP) address of the monitoring device 10, a monitoring start time, and a monitoring end time. For the monitoring start time, the user may issue a monitoring message to control the mobile image capturing device 30 to capture the monitoring image in real time, or set a predetermined time and a monitoring time length to make the mobile image capturing device 30 automatically transmit the image of the disposition site obtained by the mobile image capturing device 30 back to the monitoring device 10, so as to achieve a subscription monitoring mechanism.

To sum up, in the wireless remote monitoring system of the present invention, the image captured by the remote mobile image capturing device 30 is transmitted by using the WiMAX communication protocol, such that the transmission of the full-frame image is faster than the transmission through a fixed data dedicated line or a wireless FSK modem. When no image is transmitted, the mobile image capturing device 30 automatically enters a power-saving mode through the power source control circuit 306. To be completed within only 2% of a working duty, the image transmission can be finished with a power lower than 0.1 W by using the WiMAX communication protocol. The WiMAX communication protocol provides a bandwidth wide enough to connect the mobile image capturing devices 30, so as to conveniently collect and manage information from different places.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A wireless remote monitoring system, comprising:
at least one mobile image capturing device, having a mobile power source installed thereon, for obtaining an image of a disposition site; and
a monitoring device, connecting to the mobile image capturing device through a communication network by using a worldwide interoperability for microwave access (WiMAX) communication protocol, for transmitting a monitoring message to the mobile image capturing device, and receiving the image of the disposition site.

2. The wireless remote monitoring system according to claim 1, wherein the monitoring device is a computer.

3. The wireless remote monitoring system according to claim 1, wherein the monitoring device is a mobile communication device.

4. The wireless remote monitoring system according to claim 1, wherein the monitoring device is a personal digital assistant (PDA).

5. The wireless remote monitoring system according to claim 1, wherein the mobile image capturing device is a web camera.

6. The wireless remote monitoring system according to claim 1, wherein the mobile power source is a solar power device.

7. The wireless remote monitoring system according to claim 1, wherein the mobile power source is a fuel cell.

8. A wireless remote monitoring method, comprising:
transmitting a monitoring message to a communication network by a monitoring device through a worldwide interoperability for microwave access (WiMAX) communication protocol;
connecting the communication network to a mobile image capturing device, for transmitting the monitoring message;
determining and processing the received monitoring message by the mobile image capturing device; and
transmitting an obtained image back to the monitoring device by the mobile image capturing device according to the monitoring message.

9. The wireless remote monitoring method according to claim 8, wherein the monitoring message further comprises a monitoring start time.

10. The wireless remote monitoring method according to claim 9, wherein the monitoring start time is same as the time when the monitoring message is transmitted.

11. The wireless remote monitoring method according to claim 9, wherein the monitoring start time is a predetermined time different from the time when the monitoring message is transmitted.

12. The wireless remote monitoring method according to claim 11, wherein the monitoring message further comprises a monitoring end time.

13. The wireless remote monitoring method according to claim 11, wherein the monitoring message further comprises a monitoring time length.

14. A mobile image capturing device, comprising:
a mobile power source, for providing an electric power required by the mobile image capturing device;
an image capture module;
a signal receiving/transmitting interface; and
a processor, for controlling the image capture module to obtain an image of a disposition site of the mobile image capturing device, and transmitting the image to a monitoring device through the signal receiving/transmitting interface by using a worldwide interoperability for microwave access (WiMAX) communication protocol.

15. The mobile image capturing device according to claim 14, wherein the monitoring device is a computer.

16. The mobile image capturing device according to claim 14, wherein the monitoring device is a mobile communication device.

17. The mobile image capturing device according to claim 14, wherein the monitoring device is a personal digital assistant (PDA).

18. The mobile image capturing device according to claim 14, wherein the mobile image capturing device is a web camera.

19. The mobile image capturing device according to claim 14, wherein the mobile power source is a solar power device.

20. The mobile image capturing device according to claim 14, wherein the mobile power source is a fuel cell.
